(19) United States
(12) Patent Application Publication
(10) Pub. No.: US 2021/0398128 A1
(43) Pub. Date: Dec. 23, 2021

(54) VELOCITY SYSTEM FOR FRAUD AND DATA PROTECTION FOR SENSITIVE DATA

(71) Applicant: ID Metrics Group Incorporated, Kirkland, WA (US)

(72) Inventor: Richard Austin Huber, JR., Weehawken, NJ (US)

(21) Appl. No.: 17/355,090

(22) Filed: Jun. 22, 2021

Related U.S. Application Data
(60) Provisional application No. 63/042,527, filed on Jun. 22, 2020.

(51) Int. Cl. G06Q 20/40; G06N 20/00; G06K 9/00

(52) U.S. Cl. CPC G06Q 20/4016; G06K 9/00442; G06N 20/00

(57) ABSTRACT

Methods, systems, and apparatus, including computer programs encoded on computer-storage media, for updating a shared database and processing transactions. In some implementations, first data related to a transaction is received by a first enterprise transaction verification system. The first enterprise transaction verification system generates second data by obfuscating the first data using a machine learning model that has been trained to include a security feature discriminator layer and obtaining a set of activations output by a security feature discriminator layer of the machine learning model. The second data includes the set of activations and can be stored on a shared database where it can be compared with other activations from other transactions to aid in authentications and detections of fraud.

### CROSS-REFERENCE TO RELATED APPLICATION

This application claims the benefit under 35 U.S.C. § 119(e) of U.S. Patent Application No. 63/042,527, entitled “VELOCITY SYSTEM FOR FRAUD AND DATA PROTECTION FOR SENSITIVE DATA,” filed Jun. 22, 2020, which is incorporated herein by reference in its entirety.

### BACKGROUND

Persons can create counterfeit documents for a variety of reasons. Detection of such counterfeit documents is an important operation for many entities including financial services organizations, retail outlets, government agencies, among many others.

### SUMMARY

According to one innovative aspect of the present disclosure, a velocity system for fraud and data protection for sensitive data is disclosed. In one aspect the method can include receiving, by a first enterprise transaction verification system, first data that represents at least a portion of a physical document identifying a party of a transaction; generating second data that represents an obfuscation of the first data, where generating the second data includes providing the first data as an input to a machine learning model that has been trained to include a security feature discriminator layer and obtaining a set of activations output by a security feature discriminator layer of the machine learning model, where the second data includes the set of activations; determining, by the first enterprise transaction verification system and based on the second data, whether the transaction is a transaction that is to be denied, based on determining that the transaction is to be denied, updating a database of a collaborative verification system to include one or more data records that comprise the second data for a predetermined amount of time, the collaborative verification system enabling preemptive denial of one or more other transactions by the party at other enterprises that are members of the collaborative verification system.

Other versions include corresponding systems, apparatuses, and computer programs to perform, or otherwise realize, the actions of methods defined by instructions encoded on computer readable storage devices.

These and other versions may optionally include one or more of the following features. For instance, in some implementations, the method can further include providing data stored by the collaborative verification system to one or more other enterprise transaction verification systems.

In some implementations, the one or more data records are accessible by one or more other enterprise verification systems of the other enterprises that are members of the collaborative verification system.

In some implementations, updating the database of the collaborative verification system to include one or more data records that comprise the second data for a predetermined amount of time can include storing, by the collaborative verification system, the second data in an entity record in a bad-actor list. In such implementations, each entity record of the bad-actor list can correspond to an entity whose transactions are to be denied for at least a predetermined amount of time.

In some implementations, the method can further include subsequent to updating the database of the collaborative verification system: receiving, by a second enterprise transaction verification system, different data that represents at least a portion of the physical document identifying a party to a different transaction and generating third data that represents an obfuscation of the different data. In such implementations, generating third data can include providing the different data as input to a second machine learning model that has been trained to include a security feature discriminator layer and obtaining a different set of activations output by a security feature discriminator layer of the second machine learning model, wherein the third data includes the different set of activations. In such implementations, the method can further include determining, by the second enterprise transaction verification system, that the third data is within a predetermined level of similarity to the second data stored in the database of the collaborative verification system, and, based on determining that the third data is within a predetermined level of similarity to the second data, determining that the different transaction is to be denied.

In some implementations, the machine learning model has been trained to determine a likelihood that data representing an input image depicts at least a portion of a legitimate physical document.

In some implementations, the security feature discriminator layer is trained to detect the presence of a document security feature in an image of the physical document or the absence of a document security feature in an image of the physical document.

According to another innovative aspect of the present disclosure, a method for transaction verification is disclosed. In one aspect, the method can include actions of receiving, by a first enterprise transaction verification system, first data that represents at least a portion of a physical document identifying a party of a transaction, generating second data that represents an obfuscation of the first data, wherein generating the second data comprises: providing the first data as an input to a machine learning model that has been trained to include a security feature discriminator layer, and obtaining a set of activations output by a security feature discriminator layer of the machine learning model, wherein the second data comprises the set of activations, storing the second data in a database of the first enterprise transaction verification system for a first predetermined amount of time, subsequent to storing the second data, determining, by a first enterprise transaction verification system, that the transaction is not a legitimate transaction, and based on determining that the transaction is not a legitimate transaction, updating a database of a collaborative verification system to include one or more data records that comprise the second data for a second predetermined amount of time, the collaborative verification system enabling preemptive denial of one or more other transactions by the party at other enterprises that are members of the collaborative verification system.

[symbol]

Other versions include corresponding systems, apparatuses, and computer programs to perform, or otherwise realize, the actions of methods defined by instructions encoded on computer readable storage devices.

Advantageous implementations can include one or more of the following features. For example, a user or entity can customize various elements of the system (e.g., amount of time data is stored within system, thresholds for fraud detection, thresholds for bad-actor listing, threshold for invoking human review, etc.).

Advantageous implementations can further include storing data, including transactions or detections of fraud, to be shared internally by a first enterprise or externally amongst two or more different enterprises. The data can be stored on a database or another data storage system. The data can be obfuscated to prevent the sharing of personally identifiable information. The obfuscation process can involve using activation output from a security feature discriminator layer of a machine learning model where the security feature discriminator layer can help provide a level of obfuscation and a non-reversibility of data. The activation output resulting from one or more transactions can be compared to determine similarities and inform detections of fraud. By abstracting elements of transaction data through the security feature discriminator layer of the machine learning model, the system can enable the comparing and sharing of data representing personally identifiable information without exposing personally identifiable information.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a contextual diagram of an example of a collaborative transaction verification system.

FIG. 2 is a flowchart of an example of a process for verifying transactions using a collaborative transaction verification system to screen transactions.

FIG. 3 is a contextual diagram of an example of a collaborative transaction verification system.

FIG. 4 is a flowchart of an example of a process for verifying transactions using a collaborative transaction verification system.

FIG. 5 is a block diagram of system components that can be used to implement a collaborative transaction verification system.

Like reference numbers and designations in the various drawings indicate like elements.

### DETAILED DESCRIPTION

The present disclosure is directed towards methods, systems, and computer programs for enabling a collaborative transaction verification system. The collaborative transaction verification system facilitates sharing of bad actor data records that each identify an entity whose transactions are to be denied between different enterprises. This sharing of bad actor data records enables a second enterprise to benefit from bad actor data records generated by a first enterprise. Such sharing of information can be discouraged, and even prohibited in certain circumstances, due to reasons related to consumer privacy protection. However, the present disclosure can achieve a collaborative transaction verification system that shares bad actor data records between different enterprises while also satisfying relevant regulations. The present disclosure achieves this benefit by generating a special type of obfuscated bad actor data record referred to as an identification template that can be used to identify bad actors across enterprises while also concealing the bad actor's identity.

For purposes of this specification, an “enterprise” can include any entity that provides a product or service for sale, lease, or other form of enjoyment, to another entity. The terms product or service are intended to be viewed broadly and can include any product or service including, but not limited to, for example, a product sale, a product rental, a telecommunications service, a financial product, a financial service, or any other form of product or service. An entity can include a person, a small business, corporation, a government office or agency, or any other organization.

In some implementations, each obfuscated identification template can include activation data output by a hidden layer of a machine learning model. In some implementations, the machine learning model can include a machine learning model that has been trained to determine a likelihood that input data representing an image depicts at least a portion of a legitimate physical document. The activation data itself, which is generated by a hidden layer of the machine learning model as the machine learning model processes input data representing an image of at least a portion of a physical document, can be used to uniquely identify an entity such as a person linked to the physical document depicted by the image data processed by the machine learning model. This identification template is secure and cannot be decoded to reveal the image of a physical document that was processed by the machine learning model to cause the hidden layer of the machine learning model to generate the activation data. Thus, this identification template provides significant security advantages in applications that include sharing of customer information across enterprises such as transaction verification applications.

Though the obfuscated identification template can conceal the identity of the person linked to a physical document in instances where the obfuscated identity template is shared across computing platforms - it is important to note that the obfuscated identification template is not “encrypted data.” Such encrypted data is typically generated by applying an encryption algorithm to target data to conceal the content of the target data. This is significant because target data that has been encrypted using an encryption algorithm can be decrypted using one or more of a decryption algorithm, private key, the like, or some combination thereof. In contrast, the identification template of the present disclosure is generated using activation data output by a hidden layer of a machine learning model such as a machine learning model that has been trained to determine a likelihood that input data representing an image depicts at least a portion of a legitimate physical document. This activation data cannot be decoded to, for example, reveal the image of a physical document that was processed by the machine learning model to cause the hidden layer of the machine learning model to generate the activation data—even if one is in possession of the machine learning model. This makes the obfuscated identification template described herein ideal for sharing across customer or transaction authentication/verification platforms while protecting the identity of the person linked to the physical document that was processed to generate the activation data.

In some implementations, a legitimate physical document is a document that complies with a legitimate anticounterfeiting architecture. In other implementations, a legitimate document can be any document that is determined to be legal and authorized by a particular law, rule, or regulation. A legitimate physical document is not a counterfeit physical document. A counterfeit physical document can include a document that does not comply with a legitimate anticounterfeiting architecture. A legitimate anticounterfeiting architecture, which may be referred to herein as an “anticounterfeiting architecture,” can include a group of two or more anticounterfeiting security features whose collective presence or absence in an image of a physical document provides an indication of the physical documents legitimacy. For purposes of this disclosure, a physical document can include a driver's license, a passport, or any form of physical identification that includes a facial image of a person identified by the form of physical identification. “Security features” of an anticounterfeiting architecture is a term that refers to a feature of an anticounterfeiting architecture whose presence or absence in an image of a physical document can be detected by a machine learning model trained in accordance with the present disclosure.

In some implementations, a machine learning mode of the present disclosure can include a security feature discriminator layer. A security feature discriminator layer of a machine learning model is a layer that has been trained to detect the presence of a security feature of a document, the absence of a security feature of a document, incorrect security features of a document, or abnormal security features of a document. In accordance with the present disclosure, a security feature can be any attribute of a physical document that is indicative of the legitimacy of the physical document. Security features can include presence, absence, or placement of natural background, artificial background, natural lighting, artificial lighting, natural shadow, artificial shadow, absence of flash shadow such as a drop shadow, head size abnormalities, head aspect ratio abnormalities, head translation abnormalities, abnormal color temperatures, abnormal coloration, aligned and configured flash lighting, off-angle illumination, focal plan abnormalities, bisection of a focal plane, use of fixed focal length lenses, imaging effects related to requanitization, imaging effects related to compression, abnormal head tilt, abnormal head pose, abnormal head rotation, non-frontal facial effects, presence of facial occlusions such as glasses, hats, head scarfs, or other coverage, abnormal head shape dynamics, abnormal head aspect ratio to intereye distances, abnormal exposure compensation between foreground and background, abnormal focus effects, image stitching effects indicating different digital sources, improper biometric security feature printing, improper security feature layering such as improper OVD, OVI, hologram, other secondary security feature overlays over a face or other portion of a document, improper tactile security feature placement near face, over a face, or other portion of a document, improper final face print, improper laser black and white, improper color laser, improper layered ink print, improper printing techniques, improper print layer sequencing, improper materials used to construct the physical document, a threshold level of material degradation of the physical document (e.g., scratches, cuts, bends, color fading, color bleeding, or the like), text features of a physical document (e.g., name, address, biographical information, or another other text), a 2D PDF-417 encoding, other form of bar code or QR code, placement of the 2D PDF-417/bar code/QR code, or the like. In some implementations, a security feature may include the relation such as a spatial relationship between two or more security features. This list of security features is not exhaustive and other types of security features can exist or be created that fall within the scope of the present disclosure.

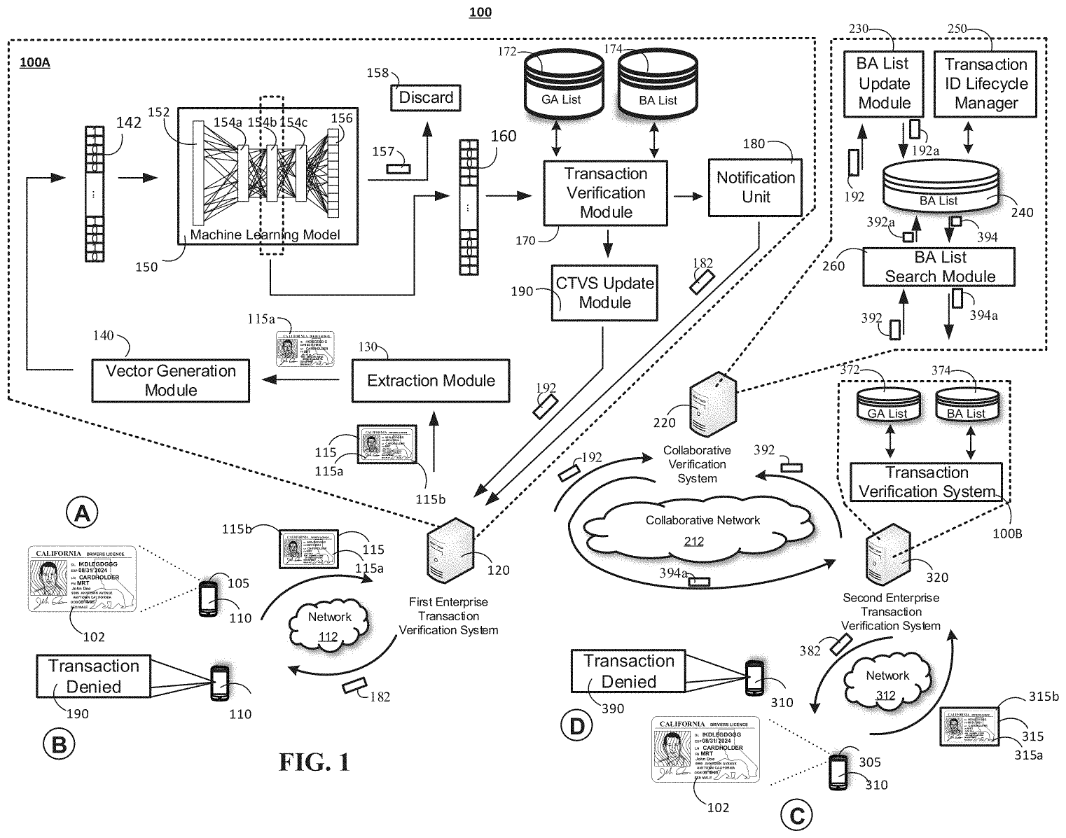

FIG. 1 is a contextual diagram of an example of a collaborative transaction verification system. The system 100 can include one or more user devices 110, 310, a first enterprise transaction verification server 120, a second enterprise transaction verification system 320, a collaborative transaction verification server 220, and one or more networks 112, 212, 312.

The first enterprise transaction verification server 120 can include a first transaction verification system 100A. The first transaction verification system 100A can include an extraction module 130, a vector generation module 140, a machine learning model 150, a transaction verification module 170, a first GA (“good-actor”) list 172, a first BA (“bad-actor”) list 174, a notification unit 180, and a collaborative transaction verification system (CTVS) update module 190.

The first enterprise transaction verification server 120 can communicate with a collaborative network 212. Each of the components of the first enterprise transaction verification server 120 can be hosted on a single computer or hosted across multiple computers that are configured to communicate with each other using one or more networks. For purposes of this specification, a “module” can include software, hardware, or any combination thereof, that is configured to perform the functionality attributed to the “module” by the present disclosure. The system 100 is described as a process from stage A to stage B in reference to the first enterprise transaction verification server 120 and from stage C to stage D in reference to the second enterprise transaction verification system 320.

With reference to the example of FIG. 1, an entity such as a person that purports to be associated with an organization such as company “X” seeks to complete a first transaction such as purchasing 100 widgets from a first enterprise ABC Inc. at stage A. To facilitate this first transaction, the person can present a physical document 102 as a form of identification. A camera of a user device 110 can be used to capture an image 115 of the presented physical document 102. The user device 110 can communicate with a first enterprise transaction verification server 120 using one or more networks 112.

The image 115 can include a first extracted image portion 115a that depicts at least a portion of the physical document 102 and a second portion 115b that depicts a portion of the surrounding environment when the image 115 of the physical document 102 was captured. The user device 110 can transmit the image 115 to the first enterprise transaction verification server 120 using the network 112. The networks represented (e.g., the network 112, the collaborative network 212, the network 312, etc.) can include a wired network, a wireless network, a LAN, a WAN, a cellular network, the Internet, or any combination thereof.

Though the example of FIG. 1 shows a user device 110 in the form of smartphone being used to capture the image 115, the present disclosure should not be so limited. For example, instead of the user device 110, a camera without voice calling capabilities can be used to capture the image 115. Then, the camera can transmit the image 115 to the first enterprise transaction verification server 120 using the network 112. In other implementations, the camera without voice calling capabilities may capture the image 115 and communicate the image 115 to another a computer. This can be achieved via one or more networks such as a Bluetooth shortwave radio network or via a direct connection to the computer using, for example, a universal serial bus (USB) type C cable. Then, in such implementations, the computer can be used to transmit the image 115 to the first enterprise transaction verification server 120 using the network 112. In yet other implementations, the camera can be part of another user device such as a tablet, a laptop, smart glasses, or the like, each of which can be equipped with a camera and image transmitting device. In general, any device capable of capturing images can be used to capture an image such as the image 115.

The first enterprise transaction verification server 120 can receive image 115 and provide the image 115 as an input to the extraction module 130. The extraction module 130 can extract the first extracted image portion 115a of the physical document 102 from the image 115 and discard a second portion 115b of the image 115. This functionality can serve the purpose of removing portions of the image 115 that do not depict a portion of the physical document 102. However, in other implementations, the extraction module 130 can be used to extract only a portion of the first extracted image portion 115a of the image 115. For example, the extraction module 130 can be configured to only extract the profile image of a person's face from the first portion 115a of the image 115. Indeed, the extraction module can be configured to extract any portion of the first extracted image portion 115a of the image 115 depicting at least a portion of the physical document 102.

The first enterprise transaction verification server 120 can provide the extracted image portion 115a of the image 115 to the vector generation module 140. With reference to the example of FIG. 1, the extracted portion of the image 115 includes the extracted image portion 115a can correspond to a first portion of the image 115. In this example, the extracted image portion 115a of the image 115 includes an image of the physical document 102 after a second portion 115b of the image 115 has been removed. The vector generation module 140 can process the extracted image portion 115a of the image 115 and generate a vector 142 that numerically represents the extracted image portion 115a of the image 115. For example, the vector 142 can include a plurality of fields that each correspond to a pixel of the extracted image portion 115a of the image 115. The vector generation module 140 can determine a numerical value for each of the fields that describes a corresponding pixel of the extracted image portion 115a of the image 115. The determined numerical values for each of the fields can be used to encode the security features of the anticounterfeiting architecture of the physical document 102 depicted by the extracted image portion 115a of the image 115 into a generated vector 142. The generated vector 142, which numerically represents the extracted image portion 115a of the image 115, is provided as an input to the machine learning model 150.

The machine learning model 150 can include any machine learning model that processes data through multiple layers such as one or more neural networks. The machine learning model 150 includes a number of layers. These layers can include an input layer 152 that is used for receiving input data such as the input vector 142, one or more hidden layers 154a, 154b, or 154c that are used to process the input data received via the input layer 152 or activation data produced by a preceding hidden layer, and an output layer 156 such as a softmax layer that is configured to operate on activation data produced by a final hidden layer. Each hidden layer 154a, 154b, or 154c of the machine learning model 150 can include one or more weights or other parameters. The weights or other parameters of each respective hidden layer 154a, 154b, or 154c can be adjusted so that the trained model produces the desired target vector corresponding to each set of training data.

The output of each hidden layer 154a, 154b, or 154c can include activation data. In some implementations, this activation data can be represented as an activation vector comprising a plurality of fields that each represent a numerical value generated by the hidden layer. The activation vector output by each respective hidden layer can be propagated through subsequent layers of the model and used by the output layer to produce output data 157. In some implementations, the output layer 156 can perform additional computations on a received activation vector from the final hidden layer 154c in order to generate neural network output data 157.

Though the example of FIG. 1 only shows three hidden layers 154a, 154b, and 154c, the present disclosure is not so limited. One or more hidden layers may constitute a full array of hidden layers within the machine learning model 150. Thus, the number of hidden layers may be less than, equal to, or greater than the three hidden layers shown in FIG. 1.

The machine learning model 150 can be trained to configure one or more of the hidden layers 154a, 154b, or 154c to function as a security feature discriminator layer. A security feature discriminator layer can include one or more hidden layers of a neural network that have been trained to include security feature discriminators. Each security feature discriminator can be configured to detect the presence or absence of a particular security feature of an anticounterfeiting architecture. Detecting the presence or absence of a particular security feature of an anticounterfeiting architecture can include detecting the presence or absence of a single security feature. However, in some implementations, detecting the presence or absence of a particular security feature can include detecting relationships such as spatial relationships between multiple different security features. Thus, a security feature discriminator of the security feature discriminator layer can be trained to detect, as a security feature, whether or not a group of one or more security features are placed within a particular location of a physical document individually or with reference to one or more other security features. The one or more hidden layers 154a, 154b, or 154c can be trained to include a security feature discriminator layer using an autoencoding process.

Autoencoding is a training process for generating one or more deep neural network layers that uses a feedback loop for adjusting weights or other parameters of a deep neural network layer until the deep neural network output layer begins to drive deep neural network output data that accurately classifies labeled input data processed by the deep neural network into a particular class specified by the label of the input data. In some implementations, the output data can include a similarity score. The output similarity score can then be evaluated such as by applying one or more thresholds to the output similarity score to determine a class for the input data. With reference to FIG. 1, the vector 142 that represents the extracted image portion 115a is input into the input layer 152 of the machine learning model 150, processed through each layer of the machine learning model 150, and output data 157 is generated based on the machine learning model's 150 processing of the vector 142.

The autoencoding of the one or more hidden layers 154a, 154b, 154c as security feature discriminator layers can be achieved by performing multiple iterations of obtaining a training image that depicts at least a portion of a physical document from a training database, extracting a portion of the training image for use in training the machine learning model 150 (if a relevant portion of training image has not already been extracted), generating an input vector based on the extracted portion of the training image, using the machine learning model 150 to process the generated input vector, and execute a loss function that is a function of the output generated by the machine learning model 150 and a label of the training image that corresponds to the training image represented by the input data vector processed by the machine learning model 150. The system 100 can adjust values of parameters of the machine learning model 150 based on outputs of the loss function at each iteration in an effort to minimize the loss function using techniques such as stochastic gradient descent with backpropagation or others. The iterative adjusting of values of parameters of the machine learning model 150 based on the output of the loss function is a feedback loop that tunes values of weights or other parameters of one or more of the hidden layers 154a, 154b, and 154c until the output data begins to match, within a predetermined amount of error, the training label of an image corresponding to the input data vector processed by the machine learning model 150 to produce the output data.

In the example shown in FIG. 1, the activation data 160 is shown as output of hidden layer 154b. The activation data 160 is the output activation data generated by the hidden layer 154b based on the hidden layer 154 b processing input data that it received. In the present disclosure, the hidden layer 154b is a security feature discriminator layer that trained to detect the presence of a document security feature of a document or the absence of the document security feature. As a point of distinction, the activation data 160 is obtained from the hidden layer 154b (e.g., a security feature discriminator layer) is generated by the hidden layer 154b (e.g., a security feature discriminator layer) and output by the hidden layer 154b (e.g., a security feature discriminator layer). The activation 160 is not the output 157 of an output layer 156 of the machine learning model 150.

The security feature discriminator layer can receive and process a representation of an extracted image portion 115a. In some implementations, the representation of the extracted image portion 115a that the security feature discriminator layer receives and processes can include the input vector 142 that can be provided to the security feature discriminator layer directly or as an output of a preceding layer such as the input layer 152. In some implementations, representation of the extracted image portion 115a received and processed by the security feature discriminator layer can include the output of another hidden layer such as hidden layer 154a. Regardless of its precise origin, form, or format, the input data received and processed by the security feature discriminator layer represents the extracted image portion 115a.

The output data generated by the security feature discriminator layer (e.g., hidden layer 154b) based on the security feature discriminator layer processing input data representing the extracted image portion 115a is the activation data 160. Generation of the activation data 160 by the security feature discriminator layer (e.g., hidden layer 154b) includes encoding, by the security feature discriminator layer (e.g., hidden layer 154b), data representing the presence or absence of security features of an anticounterfeiting architecture depicted in an image of a physical document (e.g., extracted image portion 115a) that corresponds to the input data processed by the security feature discrimination layer.

The activation data 160 can be used as an obfuscated identification template for the physical document 102, at least a portion of which is depicted by the extracted image portion 115a of the image 115 and represented by the input vector 142. In some implementations, the activation data 160 can include data produced by a particular hidden layer (e.g., a security feature discriminator layer). This data produced by the hidden layer can represent a set of parameters produced by processing elements such as neurons of the particular hidden layer (e.g., a security feature discriminator layer) based on the particular hidden layer processing input data representing extracted image portion 115a. By way of example, the set of parameters can include outputs of one or more neurons of the hidden layer, weights related to such outputs, the like, or any combination thereof. In one implementation, for example, the activation data 160 can be an extracted binary representation of particular image data represented by the input vector 142, weights or values produced by respective neurons of the hidden layer (e.g., security feature discriminator layer) related to the extracted binary, or a combination thereof. In such implementations, the binary values can correspond to specific features of an extracted image portion 115 as that are recognized by the particular implementation of a security feature discriminator layer based on processing data representing the extracted image portion 115a and can include information such as whether a particular security feature is present or absent in the data representing the extracted image portion 115a that is processed by the security feature discriminator layer.

The activation data 160 output by a security feature discriminator layer (e.g., a hidden layer 154a, 154b, or 154c) is encoded with data indicating whether each of one or more security features, of a particular anticounterfeiting architecture on which the security feature discriminator layer was trained, are present or absent in the input data representing the extracted image portion 115a that was processed by the security feature discriminator layer. The encoding of the presence or absence of the security features of a particular anticounterfeiting architecture, by the security feature discriminator layer, into the activation data 160 creates an obfuscated identification template that represents the physical identification document that corresponds to the extracted image portion 115a.

An obfuscated identification template can uniquely identify a particular physical identification document (e.g., physical document 102), with even the slightest differentiation in security features of a physical document resulting in a different encoding of the activation data. For example, a trained security feature discriminator layer can generate different activation data for respective images of a physical document based on subtle distinctions such as different head position of profile images in the images of the physical documents, different lighting conditions in the images of the physical documents, different spatial relationships of security features in the images of the physical documents, different ink characteristics of text/graphics/images in images of the physical documents, presence of a barcode in a first image of a physical document and absence of the barcode in the second image of the physical document, and the like. Though these examples are presented here, they are not intended to be limiting. Instead, these are provided to illustrate the point that any distinction between presence, absence, arrangement (e.g., spatial arrangement of one or more security features), or quality of security features (e.g., ink quality, print quality, materials quality, etc.) in images of different physical documents can be detected by the security feature discriminator layer and cause the security feature discriminator layer to generate a different set of activation data 160 as an output, thus enabling the activation data 160 to be used as an obfuscated identification template corresponding to a particular physical document.

In some implementations, the activation data 160 can be produced using unsupervised learning techniques. For example, because of the use of unsupervised learning, the weighting and composition of generated activation data such as the activation data 160 generated by the hidden layer 154b will be within a predetermined margin of error of another set of activation data generated by the hidden layer 154b each subsequent time an input vector 142 representing the extracted image portion 115a of the image 115 is processed by the machine learning model 150. Thus, absent additional training, retraining, or a combination thereof, a hidden security feature discriminator layer 154b of the machine learning model 150 can reliably generate activation data that can be used as an identification template for the physical document 102. However, the present disclosure need not be limited to processing images of an entire physical document 102. Instead, in some implementations, the activation data 160 can be used to create an obfuscated identification element based on processing data representing an image of only a portion of the physical document 102.

The activation data 160 can uniquely identify a particular physical document presented by a party to a transaction. The unique identification property of the activation data arises as a result of the encoding of security features of the physical document 102 as depicted in an extracted image portion 115a of the image 115. In some implementations, the hidden layer 154b has been trained, for example, using the autoencoding process described herein, to detect the presence or absence of security features of the security features of the physical document 102 as depicted by the extracted image portion 115a of the image 115. As a result, the activation data 160 generated by the hidden security feature discriminator layer 154b and shown in this example as activation data 160 represents an encoding of data representing the presence, absence, arrangement, or quality of security features of the physical document 102 that are depicted by the extracted image portion 115a of the image 115.

In some implementations, the encoded data can indicate that a security feature is present, but of low quality. Alternatively, in some implementations, the detection of a low quality security feature (e.g., poor lighting for profile image) may be encoded into the activation data as the absence of a security feature (e.g., appropriate lighting conditions). Similarity, the detection of appropriate lighting conditions in a profile image may be encoded into the activation data as the presence of a security feature (e.g., appropriate lighting conditions). Likewise, in some implementations, the encoded data can indicate that one or more security features were not spatially arranged in an appropriate manner. Alternatively, in some implementations, the detection of an improper spatial arrangement of one or more security features may be encoded into the activation data as the absence of a security feature (e.g., 2D PDF-417 not present where expected). Similarly, proper spatial location of one or more security features can be encoded into the activation data as the presence of a security feature (e.g., 2D PDF-417 present where expected).

The activation data 160 can be provided as an input to the transaction verification module 170. The transaction verification module 170 can determine whether a transaction requested by the entity that presented the physical document 102 should be permitted or denied. The transaction verification module 170 can make this determination by determining whether the activation data 160 generated by the hidden layer 154b of the machine learning model 150 based on the machine learning model's 150 processing of the generated input vector 142 matches a corresponding vector stored in the good-actor list 172, the bad-actor list 174, or neither the good-actor list 172 or the bad-actor list 174.

The good-actor list 172 can include a database, data structure, or other organization of data that includes data describing one or more parties whose transactions should be authorized. A party may be added to a good-actor list for a number of reasons such as achieving a number of on-time payments or other legitimate transaction activity. The good-actor list 172, depending on the particular implementation, may be used exclusively by a given enterprise within a local network of transactions or be provided more broadly to other enterprises. In some implementations, the data describing the party whose transaction should be authorized can include activation data previously generated by a hidden layer 154b of a machine learning model 150 or a hidden layer of another machine learning model that has been trained in the same manner as machine learning model 150. This activation data can be the output of a hidden layer of one of these machine learning models in the same manner as the activation data 160 shown in FIG. 1.

This stored activation data stored on the good-actor list 172 can function as an identity template of a physical document associated with an entity whose transactions have been pre-verified. In some implementations, data describing one or more parties whose transactions should be authorized may be stored in the good-actor list for only a predetermined amount of time such as 90 days. In such implementations, the transaction verification module 170 or other module such as a good-actor list maintenance module can be used to monitor time stamps associated with a creation date of identification templates stored in the good-actor list 172 and delete each identification template whose respective time stamp indicates a creation date that has met or exceed the predetermined amount of time for which the identity template is authorized to be stored on the good-actor list 172.

The bad-actor list 173 can include a database, data structure, or other organization of data that includes data describing one or more parties whose transactions should be denied. A party may be added to a bad-actor list for a number of reasons such being associated with a risk factor beyond a certain threshold for a given transaction, set of transactions, or predetermined amount of time. By way of example, indicators like a request for a large loan, inability to pay back money or assets that were lent, canceling a credit card transaction for a purchase after receiving and keeping the goods associated with the purchase, or the like. The bad-actor list 174, depending on implementations, may be used exclusively by a given organization within a local network of transactions or be provided more broadly to other situations, users, or enterprises. In some implementations, the data describing the party whose transactions should be denied can include activation data previously generated by a hidden layer 154b of a machine learning model 150 or a hidden layer of another machine learning model that has been trained in the same manner as machine learning model 150. This activation data can be the output of a hidden layer of one of these machine learning models in the same manner as the activation data 160 shown in FIG. 1.

This stored activation data on the bad-actor list 174 can function as an identity template of a physical document associated with an entity who has been pre-flagged for transaction denial. In some implementations, data describing one or more parties whose transactions should be denied may be stored in the bad-actor list for only a predetermined amount of time such as 90 days. In such implementations, the transaction verification module 170 or other module such as a bad-actor list maintenance module can be used to monitor time stamps associated with a creation date of identification templates stored in the bad-actor list 174 and delete each identification template in the bad-actor list whose respective time stamp indicates a creation date that has met or exceeded the predetermined amount of time for which the identity template is authorized to be stored on the bad-actor list 174.

Use of identification templates stored on the good-actor list 172 or the bad-actor list 174 instead of an image of an entity's physical identification document or other data that includes unobfuscated data that can be used to personally identify the entity provides significant security and privacy benefits—and indeed enables use of this system to privately store and share entity identification information in a secure manner. Not even encryption algorithms can achieve the level of security and privacy of the present disclosure, as it is at least possible for encrypted data to be decrypted.

The transaction verification module 170 can perform transaction verification by searching the good-actor list 172, a bad-actor list 174, or a combination of both in response to activation data 160 received by the transaction verification module 170. For example, the transaction verification module 170 can perform a search of the good-actor list 172 using received activation data 160 as a search parameter. In some instances, the transaction verification module 170 can determine that the activation data 160 matches, within a certain threshold of error, a given identification template in the good-actor list. In such instances, the transaction verification module 170 can determine that the entity that provided the physical document 102, which is represented by the input vector 142, as part of a transaction verification process has been authenticated and the transaction of the party should be approved. Alternatively, in other instances, if the transaction verification module 170 determines that the activation data 160 does not match, within the certain threshold of error, any identification template in the good-actor list 172, then the transaction verification module 170 can continue the transaction verification process by performing a search of the bad-actor list 174.

Once the good-actor list 172 has been searched, the transaction verification module 170 can perform a search of the bad-actor list 174. In some instances, such as that depicted in the example of FIG. 1 with respect to transaction verification of the first transaction, the transaction verification module 170 can determine that the activation data 160 matches, within a certain threshold of error, a given identification template in the bad-actor list 174. In such instances, such as that depicted in the example of FIG. 1 with respect to transaction verification of the first transaction for 100 widgets by a purported agent of company “X,” the transaction verification module 170 can determine that the entity that provided the physical document 102, which is represented by the input vector 142, as part of a transaction verification process for the first transaction is not authorized to complete the transaction. In such implementations, the transaction verification module 170 can instruct the notification unit 180 to generate a notification 182 indicating that the transaction for 100 widgets by the agent of company “X” should be denied. In such instances, the first enterprise transaction verification server 120 can transmit the notification 182 to the requesting user device 110 for display on a display of the user device 110 at state B. This occurs in the example of FIG. 1 and the notification 182, when processed by user device 110, can cause the user device 110 to output data indicating that the first transaction is to be denied. This output data can include an audio message such as “transaction denied” indicating that the transaction is to be denied, a visual message that display text, graphics or both indicating that the first transaction is to be denied, haptic feedback such as causing the user device 110 to vibrate indicating that the fist transaction is to be denied, or any combination thereof.

Though the example of FIG. 1 described above describes a scenario where the first transaction was denied because activation data, or an identification template, corresponding to an image of at least a portion of the physical document 102 presented by the user at stage A matched, within a predetermined similarity, an identification on the bad-actor list, the present disclosure is not so limited. Instead, the first transaction could be denied for any number of reasons not related to the bad-actor list. For example, a payment method presented by the user at stage A may have been denied.

Alternatively, in other instances, the transaction verification module 170 can determine that the activation data 160 does not match any identification templates in the bad-actor list 174. In this scenario, the transaction verification module 170 has determined that the activation data 160 does not match, within a certain threshold of error, any identification templates in the good-actor list or the bad-actor list. In such a scenario, the transaction verification module 170 can determine that the entity that provided the physical document 102, which is represented by the input vector 142, as part of a transaction verification process is authorized to complete a requested transaction. In such implementations, the transaction verification module 170 can instruct the notification unit 180 to generate a notification 182 indicating that the transaction is authorized and should be permitted. In such instances, the first enterprise transaction verification server 120 can transmit the notification to the requesting user device 110 for display on a display of the user device at state B indicating that the transaction should be permitted.

In the example of FIG. 1, the same user device that captures the image 115 and transmits the image 115 as part of transaction verification for the first transaction to the first enterprise transaction verification server 120 also receives the notification 182. However, the present disclosure need not be so limited. Instead, in some implementations, to the first enterprise verification server 120 can transmit the notification 182 to another computer. In such instances a user of another computer can convey a determination of the transaction verification process, which may be represented by notification 182 in some instances, to the user that presented the physical document 102 during transaction verification.

After analyzing activation data 160 in view of the good-actor list 172, the bad-actor list 174, or both, during transaction verification of the first transaction attempted by the user at stage A, the transaction verification module 170 can provide data to the collaborative verification system (CTVS) update module 190 based on a determination made by the transaction verification module 170 as to whether or not the transaction is authorized. In the example of FIG. 1, because the first transaction was not authorized, the transaction verification module 170 can provide data to the CTVS update module 190 indicating that the entity of the first transaction that provided the physical document 102, which is represented by the input vector 142, as part of a transaction verification process for the first transaction is not authorized to complete the first transaction. The transaction verification module 170 can instruct the CTVS update module 190 to generate a first data structure 192 that includes one or more fields structuring first transaction data, data indicating a decision of the transaction verification module 170, or a combination of both.

The first transaction data can include activation data 160 generated based on the extracted image portion 115a of the image 115 of the physical document 102. In some implementations, this first transaction data can also include transaction metadata related to the transaction attempted at state A such as time of transaction, date of transaction, location of transaction, product or service type sought for purchase or lease by the entity at stage A (e.g., widgets), number of products or services sought for purchase or lease by the entity at stage A (e.g., 100 widgets), an organization that the transacting entity is associated with (e.g., company “X”) at stage A, or any other transaction metadata related to the first transaction. The first enterprise transaction verification server 120 can transmit the first data structure 192 to the collaborative verification system 220 using the collaborative network 212. The collaborative network 212 can include any type of communication network including a wired network, wireless network, or any combination thereof. Likewise, the collaborative network 212 include one or more of an optical network, an Ethernet network, a WiFi network, a cellular network, a Bluetooth network, the Internet, or any combination thereof. The first data structure 192 thus represents data describing a bad actor associated with the first transaction.

The first data structure 192 can be received and processed by the collaborative verification system 220. For example, the collaborative verification system 220 can be input to a BA (“bad-actor”) list update module 230. The bad-actor list update module 230 receives the first data structure 192 and updates the collaborative BA (“bad-actor”) list 240 based on the information included in the first data structure. In some implementations, this may include storing the activation data 160, which may be referred to as an identification template, generated by the first enterprise transaction verification server 120 in the collaborative bad-actor list 240.

In other implementations, the bad-actor list update module 230 can update the collaborative bad-actor list 230 to store transaction metadata in association with the stored activation data 160. That is, bad-actor list update module 230 can generate a transaction record that is indexed by a corresponding set of activation data 160 and include metadata associated with a denied transaction such as the transaction attempted at stage A. The transaction metadata associated with the transaction such as time of transaction, date of transaction, location of transaction, product or service type sought for purchase or lease by the entity at stage A (e.g., widgets), number of products or services sought for purchase or lease by the entity at stage A (e.g., 100 widgets), an organization that the transacting entity is associated with (e.g., company “X”) at stage A, or any other transaction metadata related to the first transaction. Such transaction metadata can be mined by collaborative verification system 220 or other enterprise transaction verification systems such as second enterprise transaction verification system 320 in order detect subsequent future nefarious transactions by the entity that was a party to a transaction at stage A. In some implementations, both the activation data 160 and the transaction metadata can be stored in the collaborative bad-actor list 240.

In yet other implementations, the bad-actor list update module 230 can determine a transaction value for the first transaction that was denied at by the first enterprise transaction verification server 120 before updating the collaborative bad-actor list 240. In such instances, the bad-actor list 240 may only update the collaborative bad-actor list 240 if the bad-actor update module 230 determines that a transaction value for the first transaction that was denied satisfies a predetermined threshold. In some implementations, the transaction value may be a dollar value of the transaction. In this example, a transaction value could be determined by, for example, multiple the number of widgets purchased by the cost of the widget. In other implementations, the transaction value can be determined in other ways and may have weight values or different values such a value representative an impact of the transaction to a business. Such an impact value may be particular advantageous as a transaction having particular dollar value may have a greater or lesser impact based on the size of business, the business model of a business, or the like. Alternatively, if a transaction value is determined to not satisfy a predetermined threshold, then the bad-actor update module 230 may determine to not update the collaborate bad-actor list 240.

The advantages of the present disclosure that enable bad actor information sharing amongst different enterprise transaction verification systems are achieved by storing the activation data 160 in the bad-actor list—instead of user identifiable information—or using the activation data to index transaction metadata related to transactions attempted by the bad actor corresponding to the activation data 160, or a combination of both. Use of the activation 160 to represent the bad actor in the collaborative verification system 220 completely obfuscates the bad actor's identity in an irreversible manner and allows the bad actor's identity to be shared and stored by the collaborative bad-actor list 240.

Subsequent nefarious transactions identified by other enterprise transaction verification systems can be used to update transaction metadata records associated with and indexed by a set of activation data 160 in the collaborative bad-actor list. For example, upon receipt of a first data structure 192 having activation data 160 and transaction metadata by the bad-actor list update module 230, the bad-actor list update module 230 can first perform a search to determine whether another identification template such as a prior set of activation data that falls within a predetermined similarity threshold to the set of activation data 160 was previously received and stored by the collaborative bad-actor list 240 exists. If so, the bad-actor list update module 230 can update collaborative bad-actor list 240 to store the transaction metadata in associated with the previously stored activation data that matches the activation data 160 with a predetermined level of similarity.

Alternatively, if an identification template corresponding to the newly received activation data 160 of the first data structure 192 does not already exist in the collaborative bad-actor list 240, then the bad-actor list update module 230 can create a new entry in the collaborative bad-actor list 240 with (or without) the transaction metadata. In this manner, prior transactions attempted by a bad actor across multiple enterprises can be aggregated. Then, at a later time, such as when the bad actor tries to commit another nefarious act at a different enterprise, the different enterprises can consult the collaborative verification system 220, which can use the BA (“bad-actor”) list search module 260 to search the collaborative bad-actor list 240 for relevant identification templates, mine the collaborative bad-actor list 240 for transaction metadata describing a transaction similar to the nefarious transaction currently sought by the bad actor, a combination thereof, or the like.

A transaction identification (ID) lifecycle manager 250 can be used to maintain the collaborative bad-actor list 240. The transaction ID lifecycle manager 250 can monitor the duration of time stored data such as a timestamp that is stored in association with records in the collaborative bad-actor list 240. For example, in some implementations, data related to denied transactions such as an identification template stored in the collaborative bad-actor list 240, transaction metadata indexed by an identification template in the collaborative bad-actor list 240, or both, may only be permitted to remain stored by the collaborative bad-actor list 240 for a predetermined amount of time. In such implementations, the transaction ID lifecycle manager module 250 or other module such as a bad-actor list maintenance module can be used to monitor time stamps associated with a creation date of identification templates stored in the collaborative bad-actor list 240, transaction metadata stored in the collaborative bad-actor list 240, or both, and delete each identification template, or other data, in the bad-actor list whose respective time stamp indicates a creation date that has met or exceeded the predetermined amount of time for which the identification template is authorized to be stored by the collaborative bad-actor list 240.

The lifecycle rules governing data management of data stored by collaborative bad-actor list 240 such as the identification templates, transaction metadata, or both, can be uniform across stored collaborative verification system. For example, in some implementations, the data in the collaborative bad-actor list 240 can have a uniform lifecycle of 90 days. In some implementations, this uniform time period may be based on economic regulations, consumer protections, state laws, federal laws, or a combination thereof. In other implementations, the rules governing management of data stored by the collaborative bad-actor list 240 can be non-uniform. For example, a first set of identification templates, transaction metadata, or a combination thereof, can be stored in the collaborative bad-actor list 240 for a first time period and a second set of identification templates, transaction metadata, or combination thereof can be stored in the collaborative bad-actor list for a second time period, with the second time period being different than the first time period.

In some implementations, these non-uniform time periods can be established using custom lifecycle rules associated with the respective set of data. In some implementations, the custom lifecycle rules for the respective sets of data can be determined and assigned by the enterprise that provided the data to the collaborative verification system 220. For example, a first enterprise may dictate that the collaborative bad-actor list 240 store identification templates, transaction metadata, or both, for bad actors for 30 days whereas a second enterprise may dictate that the collaborative bad-actor list 240 store identification templates, transaction metadata, or both, for bad actors for up to the legal limit permitted by law such as 90 days. In other implementations, non-uniform time periods can be set based on attributes of the data itself, and potentially be independent of the enterprise that provided by the data. For example, an identification template, transaction metadata, or both, may be sent with additional data that can be used to classify or make a rule determination for the identification template, transaction metadata, or both.

After the collaborative bad-actor list 240 has been updated to include the activation data 160 as an identification template of a bad actor, the entity whose first transaction at stage B was denied attempts to become a party to another transaction at stage C. For example, after being denied purchase of 100 widgets from the first enterprise, the bad acting entity allegedly associated with company “X” can now try to purchase the 100 widgets from a second enterprise. In the example of FIG. 1, the entity's first transaction was denied by the first enterprise because an identity template stored on the bad-actor list 174 of the first enterprise transaction server 120 matched, within a predetermined level of similarity, the activation data 160 generated by the machine learning model 150 based on the machine learning model 150 processing input vector 142 that represents at least a portion of an image 115 of the physical document 102 presented by the entity of the first transaction during the transaction verification process. Such bad-actor list data may be have been stored by the first enterprise because the first enterprise already knew that the entity that was a party to the first transaction in stage A was a bad actor.

Based on the bad acting entity's previous interactions with the first enterprise (e.g., ABC Inc.), the bad acting entity may have the idea to make another attempt at nefarious transaction at a different second enterprise (e.g., Mom and Pop's Widgets) at stage C. The thinking of the bad acting entity may be that while the first enterprise such as a widget provider ABC Inc. has caught onto the bad acting entity's schemes, the second enterprise such as a second widget provider Mom and Pop's Widgets may be unaware of such schemes. As a result, the bad acting entity can try to perform the same (or similar) nefarious acts at the second enterprise such as Mom and Pop's Widgets.

The example of FIG. 1 describes a transaction that includes the purchase of a product—i.e., widgets. However, the present disclosure need not be limited to such transactions. Instead, the present disclosure can be used for transaction verification/entity authentication during performance of any transaction or interaction between entities where entity authentication/verification occurs including, but not limited to, screening of applicants for financial services during transactions such as loan applications or credit applications, screening of applicants for telecommunications services such as cellular services or internet services or cable services, screening of applicants at security terminals, or any other type of applicant/entity screening. Accordingly, the first enterprise and the second enterprise can include any number of enterprises including, but not limited to, banks, financial institutions, airlines, government agencies, telecommunications services providers, telecommunications device providers, retailers, or any other organization.

At stage C, an entity of the second enterprise may use a camera 305 of the user device 310 to capture an image 315 of the physical document 102. The user device 310 can transmit data representing the captured image to the second enterprise transaction verification system 320. The user device 310 can communicate with the second enterprise transaction verification system 320 using the network 312. The network 312 can include a one or more wired or wireless networks such as LAN, a WAN, a cellular network, the Internet, or a combination thereof.

The second enterprise transaction verification system 320 can include the second transaction verification system 100B that is similar to the first transaction verification system 100A shown in FIG. 1. That is, the second transaction verification system 100B can include each of the modules, models, and databases described with respect to first transaction verification system 100A and perform all of the same operations described with respect to the first transaction verification system 100A. For example, the second enterprise transaction verification system 320 can generate obfuscated identification templates such as a set of activation data that represents a portion 315a of an image that is extracted from the image 315. In the example of FIG. 1, the second enterprise transaction verification system is able to use the collaborative verification system 220 to deny a nefarious transaction—even though the second enterprise transaction verification system 320 does not have an identification template corresponding, within a predetermined error threshold, to a physical document 102 of the bad acting entity, whose transaction was denied at stages A and B, stored in the bad-actor list 374.

In the example of FIG. 1, the second enterprise transaction verification system can use the second transaction verification system 100B to obtain the image 315, obtain a second extracted image portion 315a, and generate a second set of activation data that the transaction verification system can use to search the GA (“good-actor”) list 372 and the BA (“bad-actor”) list 374. The second transaction verification system 100B can determine that no identification templates in the good-actor list 372 or bad-actor list 374 match the second set of activation data within a predetermined level of similarity. Accordingly, the second transaction verification system 100B can use a transaction verification module of the second transaction verification system 100B to generate a request 392 for the collaborative verification system 220 to screen the transaction attempted at stage C. The request 392 can include a second data structure having a second set of activation data representing the physical document 102 and transaction metadata.

The second data structure of the request 392 can include one or more fields structuring data that represents the second set of activation data and second transaction metadata. The second activation data is the output of a hidden layer of the machine learning model based on the machine learning model's processing of the extracted image portion 315a. This second activation data is generated in the same way as the activation data 160 described with respect to first transaction verification system 100A. The second transaction metadata of the second data structure of the request 392 can include the same, or similar, type of transaction metadata as the data structure 192. For example, the second transaction metadata can include metadata related to the transaction attempted at state C such as time of transaction, date of transaction, location of transaction, widget or service type sought to purchase or lease by the entity at stage A, a number of widgets sought to purchase or lease by the entity at stage A, parameters of a service sought by the entity at stage A, or any other transaction metadata related to the first transaction.

The collaborative verification system 220 can receive the second data structure 392. The collaborative verification system 220 can use the bad-actor list search module 260 to mine the data stored in the collaborative bad-actor list 240 based on the data included within the second data structure of the request 392. Mining the collaborative bad-actor list 240 can include one or more of a number of different operations. For example, in some implementations, mining the collaborative bad-actor list 240 can include determining whether the second set of activation data obtained from the second data structure 392 matches, within a predetermined level of similarity, an entry on the collaborative bad-actor list 240.

By way of example, the bad-actor list search module 260 within the collaborative verification system 220 can receive the second data structure of the request 392 as input and extract the second activation data that was included in the second data structure of the request 329. The bad-actor list search module 260 can generate a search query 392a that includes the second set of activation data as a search parameter and execute the search query 392a against the collaborative bad-actor list 294. Execution of the query 392a can include, for example, performing a vector comparison between the second set of activation data and each of the identification templates stored in the collaborative bad-actor list 240. In response to the search query 392a, a set of search results 394 can be obtained by the bad-actor list search module. The search results 394 can indicate whether one or more of the identification templates matched the second set of activation data within a predetermined level of similarity. If no identification templates in the collaborative bad-actor list 240 matched the second set of activation data within a predetermined level of similarity, then the bad-actor list search module 260 can generate a response message indicating that the second set of activation data did not match any identification templates on the collaborative bad-actor list 240. Alternatively, if an identification template in the collaborative bad-actor list 240 is determined to match the second set of activation data within a predetermined level of similarity, then the bad-actor list search module 260 can generate a response message 394a based on the search results 394 that indicates that an identification template was found in the collaborative bad-actor list 240 that matches the second set activation data within a predetermined level of similarity. In either event, the response message can be transmitted back to the second enterprise verification server 320 via the network 212.

In the example of FIG. 1, because an identification template associated with the entity that is a party to the transaction at stage C was already previously stored in the collaborative bad-actor list by the first enterprise transaction verification server 120, the bad-actor list search module 260 finds an identification template that matches the second set of activation data. Accordingly, in this instance, the response message 394a indicates that a match was found and this response message is transmitted back to the second enterprise search transaction verification system 320. A notification module of the second transaction verification system 100B can generate a notification 382, based on the response message 394a, which indicates that the transaction sought by the person that is party to the transaction at stage C is to be denied because an identification template was found in the collaborative bad-actor list that matches the set of activation data representing the entity's physical document 102. The notification 382 can be transmitted to the user device 310 causing output of a notification that 390 indicating that the transaction is to be denied. This output can include, for example, an audio message such as “transaction denied” indicating that the transaction is to be denied, a visual message that display text, graphics or both indicating that the first transaction is to be denied, haptic feedback such as causing the user device 310 to vibrate indicating that the fist transaction is to be denied, or any combination thereof. As a result, even though the second enterprise transaction verification server 320 was not able to detect the bad actor and deny the transaction at stage C, based on its own local bad-actor list or good-actor list, the second enterprise transaction server 320 is able to deny the transaction attempted at stage C by the bad actor with physical document 102 as a result of its consultation of the collaborative bad-actor list 240 maintained by the collaborative verification system and routinely updated by one or more other enterprises such as the first enterprise transaction verification server 120 as bad actors are detected.

However, the present disclosure need not be so limited to determining whether the collaborative bad-actor list 240 includes an identification template that matches the second set of activation data within a predetermined level of similarity. Instead, in some implementations, mining the collaborative bad-actor list 240 can include determining whether the second transaction metadata obtained from the second data structure 392 matches, within a threshold level of similarity, one or more prior transaction records in the collaborative bad-actor list 240.

For example, in some implementations, the bad-actor list search module 260 can mine the collaborative bad-actor list 240 to determine whether it includes any transaction records that store transaction metadata from other transaction of previously identified bad actors. For example, in some implementations, the transaction at stage C may be a request to purchase 100 widgets for company “X.” In such a scenario, the second data structure 392 can include second transaction metadata such as purchase order for 100 widgets, purchasing company “X,” or a combination thereof. The bad-actor list search module 260 can extract query parameters from the second transaction metadata such as 100 widgets, “X,” or a combination thereof. The bad-actor list search module 260 can generate a query 392a that includes query parameters of “100 widgets” and “X” and execute the query 392a against the collaborative bad-actor list 240. The bad-actor list search module 260 can obtain a set of search results 394. The set of search results 394 can indicate whether there are one or more transaction records that satisfy the query 392a. In some implementations, the search results 394 may include data indication that no transaction records were identified that satisfied the search query 392a.

In other implementations, the search results 394 can include one or more transaction records that were identified as including one or more of the identified terms. For example, the bad-actor list search module 260 may identify one or more transaction records in the collaborative bad-actor list 240 that included a purchase order for 100 widgets, a request to purchase widgets for company “X,” or a combination thereof. In such instances, the bad-actor list search module can generate a notification 394a for transmission to the section transaction verification server 320 via the collaborative network 212. Upon receipt of the notification 394a, a notification module of the second transaction verification system 100B can analyze the notification 394a, determine whether the transaction at attempted at stage C should be approved or denied based on the contents of the notification 394a and generate a notification 382 that, when processed by the user device 310, causes the user device 310 to display an alert or other message indicating whether the transaction at attempted at stage C is to be approved or denied. In some implementations, the notification 394a can include data describing the one or more identified transaction records that are determined by the collaborative verification system 220 to be similar to one or more current transaction records describing the transaction attempted at stage C. In other implementations, the notification 394a can merely include data describing whether the transaction attempted at stage C is to be approved or denied.

For example, in some implementations, the notification 382 can trigger denial of the transaction attempted at stage C based on, for example, similarity of the transaction attempted at stage C to a previously attempted transaction by a bad actor at another enterprise (e.g., the first enterprise), which is what caused the transaction record to be stored in the collaborative bad-actor list 240 in the first place. In other implementations, the notification 382 may trigger further review of the transaction and further consultation with the entity that attempted the transaction at stage C before an approval or a denial of the transaction is made. For example, perhaps the entity can be asked to provide further information such as tax return information to show that company “X” exists and has resources (e.g., cash in a bank account, sufficient credit line, etc) to cover purchase of the 100 widgets. By way of another example, further review and consultation may include a prompt, by the user device 310 based on processing of the notification 382, to request a different form of payment such as a cash or money order payment instead of a credit card payment.

As illustrated, the storage of the transaction records that include data representing metadata related to a denied transaction includes a variety of advantages. In particular, the transaction records stored in the collaborative bad-actor list 240 can be a way to detect transactions by bad actors across different enterprises even in the event that the bad actor changes the physical document 102 that the bad actor presents with each transaction. Instead of a common representation of a physical identification document across different transactions, the system 100 can perform an evaluation and detection of similarity in transactions across different enterprises. This methodology can be based, in part, on the premise that a bad actor is likely to abide by trends in the nefarious transactions they attempt across different enterprises. Such trends may have similarity in types of widgets or services sought, brands of widgets or services sought, number of widgets or services sought, method of payment, company name the devices were purchased for, or any combination thereof. Each of these forms of transaction metadata can thus be evaluated in an attempt to identify attempted nefarious transactions by bad actors. Because these transaction records are indexed using identification templates, the transaction records are fully anonymous and cannot be reverse engineered.

In some instances, the term “identification template” is used to describe a representation of a physical document such as physical document 102. In addition, the term “activation data” or “activation vector” is used to describe the output of a hidden layer of the machine learning model 150. However, it is noted that in some implementations, there may not be any differences between an “identification template,” “activation data,” or an “activation vector.” In such implementations, the activation data output by the hidden layer 154b is the activation data 160 and vector representation of that activation data 160 can be used as an identification template. In other implementations, there may relatively minor formatting differences that occur between the activation data 160, activation vector corresponding to activation data 160, and identification template corresponding to activation data 160 to facilitate their respective uses in different data processing systems. For example, data fields such as a header field may added to an activation vector when making the activation data into an identification template for storage. In any event, comparisons between newly generated activation data 160, which can synonymously be referred to as an activation vector or runtime identification template, and a stored identification template are made by evaluating the activation data output by a hidden layer 154b of a machine learning model 150 trained as described herein.

[symbol]

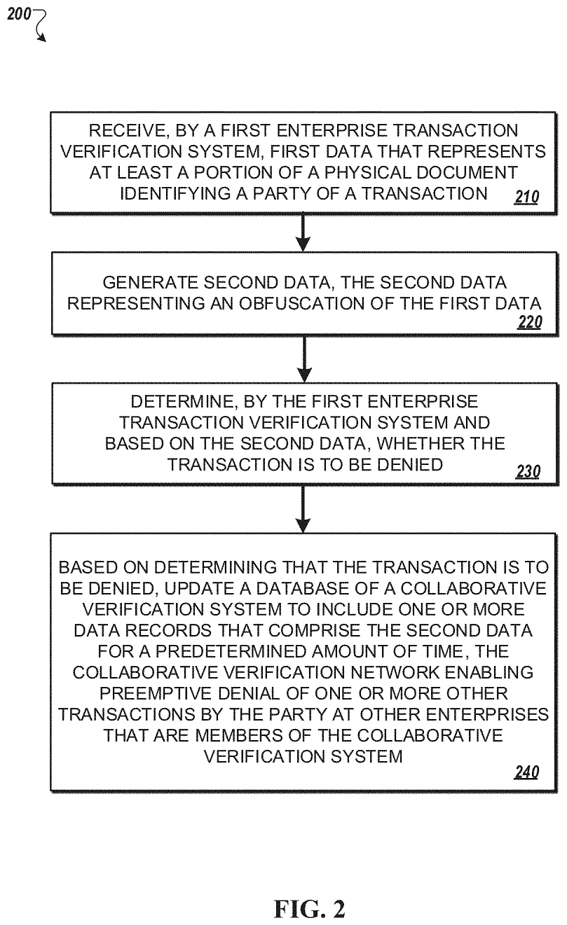

FIG. 2 is a flowchart of an example of a process 200 for verifying transactions using a collaborative transaction verification system to screen transactions. The process 200 may be performed by one or more electronic systems, for example, the system 100 of FIG. 1.

The system 100 can begin execution of the process 200 by receiving, by a first enterprise transaction verification system, first data that represents at least a portion of a physical document identifying a party of a transaction (210). In some implementations, the obtained first data can include an input vector that represents at least portion of the physical document identifying a party of the transaction. The input data vector can be generated based on at least a portion of an image of a physical document identifying a party of the transaction that was generated by a user device such as a smartphone and transmitted to a server by the user device. The image can be received across one or more wired or wireless networks such as LAN, a WAN, a cellular network, the Internet, or a combination thereof. The captured image can depict all, or a portion of, the physical document identifying a party to a transaction.

In some implementations, the obtained first data can represent multiple aspects extracted from the physical document. For example, the obtained first data can include a portion of the document, a facial image on the document, or other data such as various biographic, textual, or code based data (e.g., bar codes, quick response (QR) codes, etc.) depicted by the physical document.

The system 100 can continue execution of the process 200 by generating second data, the second data representing an obfuscation of the first data (220). In some implementations, the second data can be generated by a hidden layer of a machine learning model. For example, the obfuscation of the first data can include a set of activation data output by the hidden layer of the machine learning module as a result of the machine learning model processing the first data obtained at stage 210. In some implementations, the hidden layer of the machine learning model can include a hidden security feature discriminator layer that has been trained to detect the presence or absence of one or more security features of an anticounterfeiting architecture upon which the machine learning model has been trained.

The system 100 can continue execution of the process 200 by determining, by the first enterprise transaction verification system and based on the second data, whether the transaction is to be denied (230). For example, the system 100 can determine whether the transaction is to be denied by searching a good-actor list storing previously generated activation data representing one or more physical documents for other parties to other transactions representing entities whose transactions are to be allowed, a bad-actor list storing previously generated activation data representing one or more physical documents for other parties to other transactions whose transactions are to be denied, or a combination of both to determine whether the obtained activation data is within a predetermined amount of error of any of the instances of activations data stored in the good-actor list, bad-actor list, or both.

Based on determining that the transaction is to be denied, the system 100 can continue execution of the process 200 by updating a database of a collaborative verification system to include one or more data records that comprise the second data for a predetermined amount of time, the collaborative verification network enabling preemptive denial of one or more other transactions by the party at other enterprises that are members of the collaborative verification system (240). A data structure that includes one or more fields structuring data representing the obfuscated second data, transaction metadata, or a combination thereof, can be sent by the first enterprise transaction verification system to the collaborative verification system. At least a portion of the data structured by the data structure can be stored in by the collaborative verification network. In some implementations, the data can be stored in a collaborative bad-actor list by the collaboration network.

Other transaction verification requests from the same enterprise verification system or different enterprise verification systems can also be sent to the collaborative verification system. Data from the other transaction verification requests can be compared with data from previously stored data representing previous transactions. The data stored by the collaborative verification system is obfuscated in the manner discussed above to prevent exposing any personally identifiable information while still maintaining an ability to recognize possible instances of attempts to commit a nefarious transaction by one or more bad actors. The data stored from previously conducted transactions and parties associated with those transactions can then be used to inform current authentication and fraud detection processes for one or more of the users or enterprises that are members of the collaborative verification system.

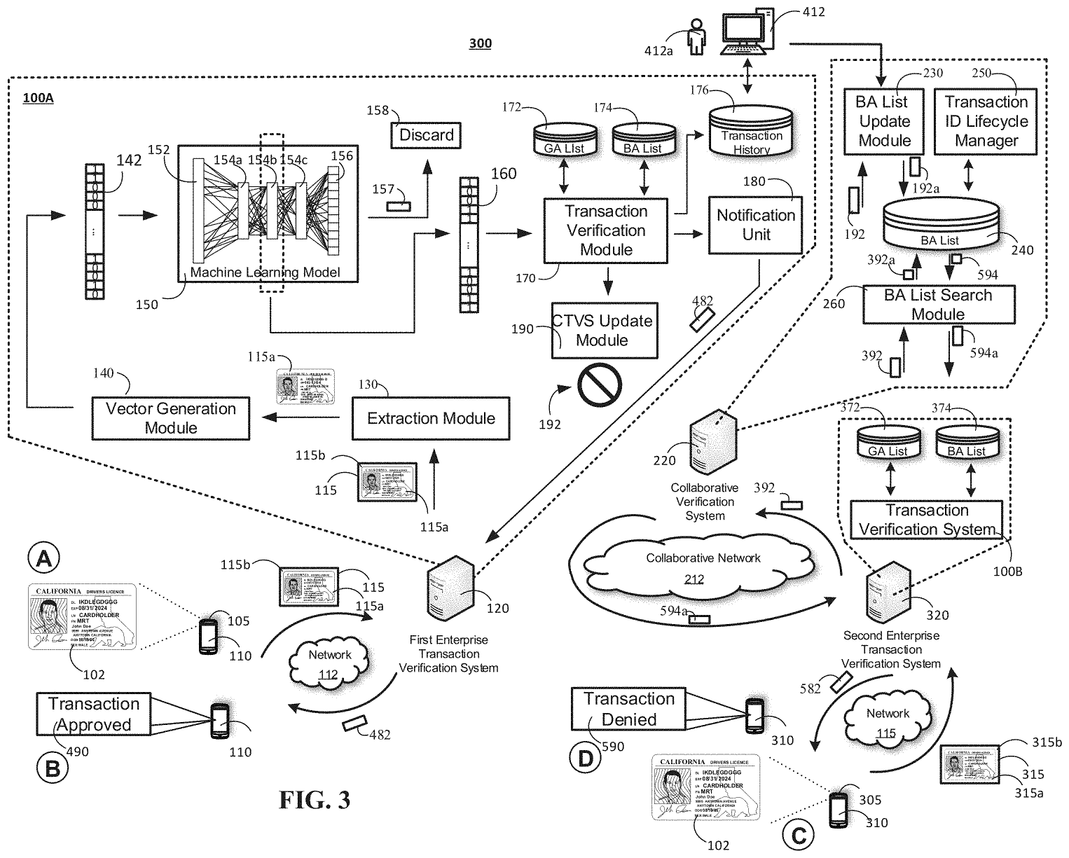

FIG. 3 is a contextual diagram of an example of a collaborative transaction verification system 300. The system 300 includes many of the same features from system 100 of FIG. 1 such, the camera 105, the user device 110, the image 115, the first enterprise transaction verification server 120, a first transaction verification system 100A, a collaborative verification system 220, networks 112, 212, 312, a second enterprise transaction verification system 320, a second transaction verification system 100B, a camera 305, and a user device 310. Indeed, the system 300 is the same as the system 100, except that the system 300 also includes a user terminal 412 that communicates with a transaction history database 176 of the first enterprise transaction verification server 120 and the bad-actor list update module 230 of the collaborative verification system 220. Such additional features of system 300 enable a user such as user 412a to review transaction records and add an identification template, transaction metadata, or both, related to a bad actor to the collaborative bad-actor list 240 at some point in time after a transaction sought by the bad actor was approved by the first enterprise transaction verification server 120. In the example of FIG. 3, a process is shown from stage A to stage B and from stage C to stage D.

With reference to the example of FIG. 3, an entity can attempt to initiate a transaction at stage A. As part of the transaction, the entity can present a physical document 102. A verifying party can use a camera 105 the user device 110 to capture an image 115 of the physical document 102. The image 115 can include an extracted image portion 115a that depicts at least a portion of the physical document 102 and a second portion 115b that depicts a portion of the surrounding environment when the image 115 of the physical document 102 was captured. The user device 110 can transmit the image 115 to the first transaction verification server 120 using the network 112. The network 112 can include a wired network, a wireless network, a LAN, a WAN, a cellular network, the Internet, or any combination thereof.

The first enterprise transaction verification server 120 can perform transaction verification of the image 115 of the physical document 102 using the process described with reference to FIG. 1. However, illustrative purposes, in the example of FIG. 3, it is assumed that an identification template that matches the activation data 160 is not found in either the good-actor list 172 or the bad-actor list 174. Accordingly, in this example of FIG. 3, the notification unit 180 can generate a notification 482 that indicates that the transaction requested at stage A is not to be denied. The notification 482 can be transmitted to the user device at stage B, and when processed by the user device 110, causes the user device 110 to output data indicating that the transaction is not to be denied. By way of example, in some implementations, the user device can output message indicating that the “Transaction is Approved.” Such message may also be output using audio data, haptic feedback, or the like.

While not dispositive on its own, the notification 482 indicates that the first enterprise transaction verification server 120 did not discover a reason that the transaction requested at stage A should be defined. In this example, a user of the user device 110 did not have any other reason to deny the transaction requested at stage A. As a result, a representative of the first enterprise can allow the transaction. Assume, for the sake of this example, the transaction was a request for a $500,000 loan by company “Y” repayable over 10 years. Here the entity that was a party to the transaction that was approved for a $500,000 loan and leaves a financial institution with $500,000 being deposited into a bank account for company “Y.” In the example of FIG. 3, the CTVS update module 190 does not update the collaborative verification system 220 because the transaction at stage A and B was approved.

However, transaction metadata related to the transaction that occurred at stages A and B can be stored in the transaction history database. Transaction history database 176 can include, for example, a transaction record for every sale, lease, loan, granting of access to a property, denial of access to a property, etc. made by the first enterprise. In this example, a transaction record storing transaction metadata such as loan amount: $500,000, payment duration: 10 years, borrower: company “Y” can be stored in the transaction history database 176. The transaction record can be indexed using the activation data 160 that was generated during screening of the transaction by the first transaction verification server 120 between stage A and stage B. The transaction history database 176 can also be updated to store data indicating loan payments received from company “Y,” data indicating that loan payments were not received from company “Y,” or other data describing the status of the loan to company “Y.”

In the example of FIG. 3, at some point in time after the approval at stage B, the entity that was a party to the transaction (or other user) fails to make a payment on the $500,000 loan. In such a scenario, the first enterprise is likely put into a position where the first enterprise will incur a financial loss.

At some point in time after the entity (or other user) stopped on the $500,000 loan for company “Y,” a user 412a can use the user device 412 to review the transaction records in the transaction history database 176. The user 412a can detect the failure of company “Y” to make a payment on the $500,000 loan in the transaction history that corresponded to the loan for company “Y.” In such a scenario, the user 412a can use the user device 412 to instruct the bad-actor list update module 230 of the collaborative verification system 220 to add the transaction record to the collaborative bad-actor list 240. Such an update to the collaborative bad-actor list 240 can prevent the entity that was a party to the transaction at stage A from scamming other enterprises associated with the collaborative verification system 220 in the same manner (e.g., by not paying loan) as the entity scammed the first enterprise. The instruction from the user device 412 can be transmitted to the collaborative verification system 220 using the collaborative network 212. The identification template, transaction metadata, or both, that were part of the transaction record stored for the transaction that was requested at stage A can be stored in the collaborative bad-actor list 240.

At a point in time after the user 412a uses the computer to update the bad-actor list 230, the entity can attempt to make another fraudulent transaction at stage C. For example, the user 412a can attempt to secure another $500,000 loan or a different 1 loan amount for company “Y”. At stage C, a representative of the second enterprise may use a camera 305 of the user device 310 to capture an image 315 of the physical document 102. The user device 310 can communicate with the second enterprise transaction verification system 320 using the network 312. The second enterprise transaction verification system 320 can include the second transaction verification system 100B that is similar to the first transaction verification system 100A shown in FIG. 1. That is, the second transaction verification system 100B can include each of the modules, models, and databases described with respect to first transaction verification system 100A and perform all of the same operations described with respect to the first transaction verification system 100A. For example, the second enterprise transaction verification system 320 can generate obfuscated identification templates such as a set of activation data that represents a portion 315a of an image that is extracted from the image 315. In the example of FIG. 1, the second enterprise transaction verification system is able to use the collaborative verification system 220 to deny a nefarious transaction—even though the second enterprise transaction verification system 320 does not have an identification template corresponding, within a predetermined error threshold, to a physical document 102 of the bad acting entity whose transaction was denied at stages A and B.

In the example of FIG. 3, the second enterprise transaction verification system 320 can use the second transaction verification system 100B to obtain the image 315, obtain a second extracted image portion 315a, and generate a second set of activation data that the transaction verification system can use to search the good-actor list 372 and the bad-actor list 374. The second transaction verification system 100B can determine that no identification templates in the good-actor list 372 or bad-actor list 374 match the second set of activation data within a predetermined level of similarity. Accordingly, the second transaction verification system 100B can use a transaction verification module of the second transaction verification system 100B to generate a request 392 to the collaborative verification system 220 to screen the transaction attempted at stage C. The request 392 can include a second data structure having a second set of activation data representing the physical document 102 and transaction metadata.

The collaborative verification system 220 can receive the request 392. The collaborative verification system 220 can use the bad-actor list search module 260 to mine the data stored in the collaborative bad-actor list 240 based on the data included within the second data structure request 392. Mining the collaborative bad-actor list 240 can include one or more of a number of different operations. For example, in some implementations, mining the collaborative bad-actor list 240 can include determining whether the second set of activation data obtained from the second data structure 392 matches, within a predetermined level of similarity, an entry on the collaborative bad-actor list 240. Alternatively, in some implementations, mining the collaborative bad-actor list 240 can include determining whether the second transaction metadata obtained from the second data structure 392 matches, within a threshold level of similarity, one or more prior transaction records in the collaborative bad-actor list 240.

In this example, regardless of the mining technique selected, the bad-actor list search module 260 can identifying information in the collaborative bad-actor list 240 associated with prior transactions of the bad actor at stage C. For example, the bad-actor list module 260 can generate query 392a that includes the second set of activation data generated by the second transaction verification system 100B. In such instances, the search results 594 will indicate that the second set of activation data matches an identification template in the collaborative bad-actor list 240, as the user 412a used the user device 412a to store the activation data 160 in the collaborative bad-actor list 240. Alternatively, the bad-actor list search module 260 can mine the collaborative bad-actor list 240 for transaction records corresponding to the transaction metadata of the transaction attempted at stage C. In such instances, the bad-actor list search module 260 can use a query 392a that includes parameters based on the transaction metadata from the transaction at stage C. In such instances, the parameters of the query 392a can include loan amount “$500,000,” payment duration “10 years,” borrower “company “Y”.” Here, the search results 594 can indicate that at least one transaction was identified where company “Y” acted in bad faith by not fulfilling payment or repayment terms (e.g., defaulting on a prior loan obligation, canceling a credit card payment for a product, etc.).

Based on search results, the bad-actor list search module can generate a notification 594a for transmission to the section transaction verification server 320 via the collaborative network 212. In the example of FIG. 3, the notification 594a can include data indicating that the transaction attempted at stage C is to be denied. Upon receipt of the notification 594a, a notification module of the second transaction verification system 100B can generate a notification 582 including data describing the one or more identified transaction records. The notification 582 can be transmitted to the user device 310 for display.

In some implementation, the notification 582 can trigger denial of the transaction attempted at stage C. The reason for the denial can be based on, for example, similarity of the transaction attempted at stage C to a previously attempted or completed transaction by a bad actor that attempted the transaction at stage C, which is what caused the transaction record to be stored in the collaborative bad-actor list 240. In other implementations, the notification 582 may trigger further review of the transaction and further consultation with the entity that attempted the transaction at stage C before an approval or a denial of the transaction is made. For example, perhaps the entity can be asked to provide further information such as proof of a threshold amount of liquid assets on hand.

As illustrated in FIG. 3, the storage of the transaction records including metadata related to a denied transaction includes a variety of advantages. In particular, the allowing a user 412a to use the user device 412 to update the collaborative bad-actor list 240 provides functionality that enables future nefarious transactions by a bad actor to be stopped at one or more second enterprises even if the bad actor was successful in completing a similar nefarious transaction at a first enterprise.

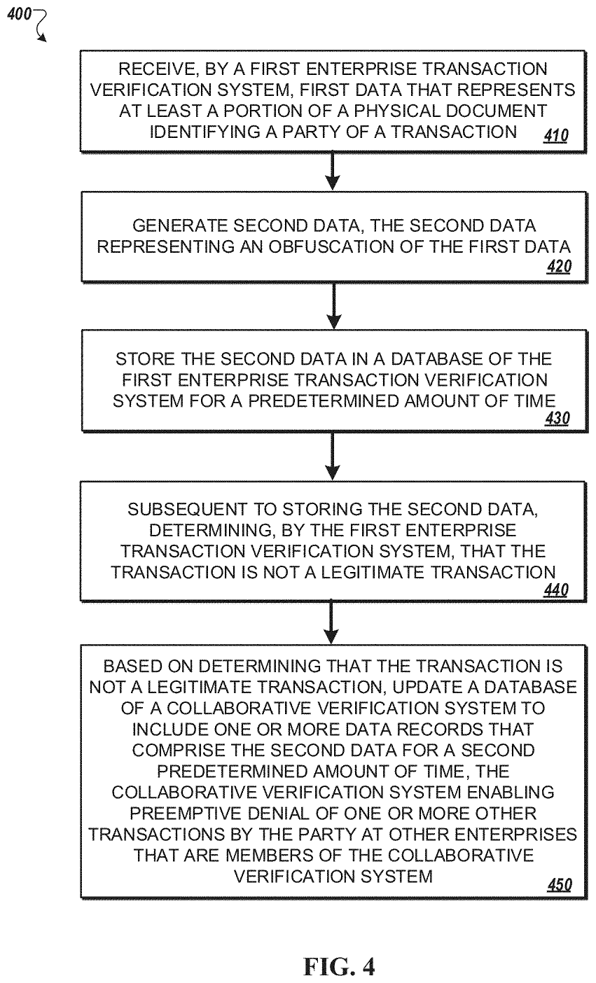

FIG. 4 is a flowchart of an example of a process for verifying transactions using a collaborative transaction verification system. The process 400 may be performed by one or more electronic systems, for example, the system 300 of FIG. 3.

The system 300 can begin execution of the process 400 by receiving, by a first enterprise transaction verification system, first data that represents at least a portion of a physical document identifying a party of a transaction (410). In some implementations, the obtained first data can include an input vector that represents at least portion of the physical document identifying a party of the transaction. The input data vector can be generated based on at least a portion of an image of a physical document identifying a party of the transaction that was generated by a user device such as a smartphone and transmitted to a server by the user device. The image can be received across one or more wired or wireless networks such as LAN, a WAN, a cellular network, the Internet, or a combination thereof. The captured image can depict all, or a portion of, the physical document identifying a party to a transaction.

In some implementations, the obtained first data can represent multiple aspects extracted from the physical document. For example, the obtained first data can include a portion of the document, a facial image on the document, or other data such as various biographic, textual, or code based data (e.g., bar codes, quick response (QR) codes, etc.) depicted by the physical document.

The system 300 can continue execution of the process 400 by generating second data, the second data representing an obfuscation of the first data (420). In some implementations, the second data can be generated by a hidden layer of a machine learning model. For example, the obfuscation of the first data can include a set of activation data output by the hidden layer of the machine learning module as a result of the machine learning model processing the first data obtained at stage 210. In some implementations, the hidden layer of the machine learning model can include a hidden security feature discriminator layer that has been trained to detect the presence or absence of one or more security features of an anticounterfeiting architecture upon which the machine learning model has been trained.

The system 300 can continue execution of the process 400 by storing the second data in a database of the first enterprise transaction verification system for a predetermined amount of time (430). In some implementations, a transaction history database such as the transaction history database 176 of FIG. 3 can be used to store the second data.

Subsequent to storing the second data at stage 430, the system 300 can continue to execute the process 400 by determining, by the first enterprise transaction verification system, that the transaction is not a legitimate transaction (440). In some implementations, determining that the transaction is not a legitimate transaction includes performing further review on data related to the transaction. For example, in FIG. 3 the human 412a performs further review on data related to the first transaction shown in stage A. The further review performed by the human 412a results in a determination that the first transaction is not authentic and should be denied.

Based on determining that the transaction is not a legitimate transaction, the system 300 can continue execution of the process 400 by updating a database of a collaborative verification system to include one or more data records that comprise the second data for a second predetermined amount of time, the collaborative verification system enabling preemptive denial of one or more other transactions by the party at other enterprises that are members of the collaborative verification system (450). For example, data related to the first transaction shown in stage A is stored in the collaborative bad-actor list 240 based on the determination made after further review. In this case, the further review is performed by the human 412a.

Data related to the second transaction shown in stage C matches elements of the data stored in the collaborative bad-actor list 240 from the first transaction shown in stage A. Based on the match, the second transaction is denied. The collaborative verification system 220 enabled denial of the second transaction by associating the party of the first transaction to the party of the second transaction. As shown by the physical document 102 used in both the first transaction and the second transaction in stage A and stage C respectively, the parties of the two transactions are the same and the collaborative verification system 220 is capable of denying the second transaction based on the fact that the party of the first transaction was deemed inauthentic by the further review performed by the human 412a. The data related to these transactions are obfuscated and so not only is an inauthentic second transaction prevented, but the privacy requirements are met as personally identifiable information is not exposed.

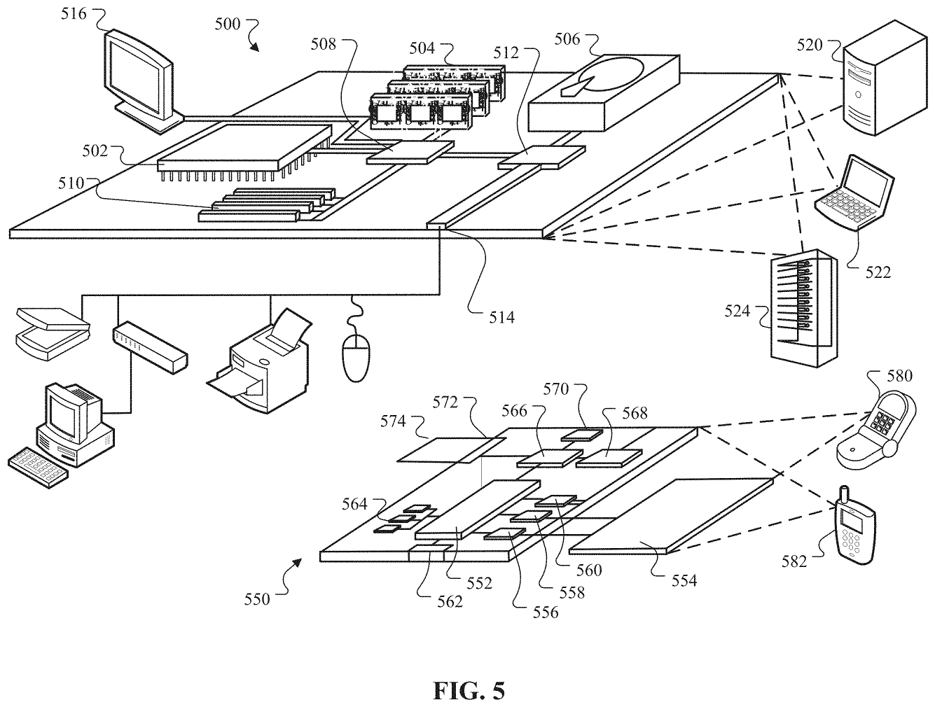

FIG. 5 is a block diagram of system components that be used to authenticate transactions. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally, computing device 500 or 550 can include Universal Serial Bus (USB) flash drives. The USB flash drives can store operating systems and other applications. The USB flash drives can include input/output components, such as a wireless transmitter or USB connector that can be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and can be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses can be used, as appropriate, along with multiple memories and types of memory. Also, multiple computing devices 500 can be connected, with each device providing portions of the necessary operations, e.g., as a server bank, a group of blade servers, or a multi-processor system.

The memory 504 stores information within the computing device 500. In one implementation, the memory 504 is a volatile memory unit or units. In another implementation, the memory 504 is a non-volatile memory unit or units. The memory 504 can also be another form of computer-readable medium, such as a magnetic or optical disk.

The storage device 506 is capable of providing mass storage for the computing device 500. In one implementation, the storage device 506 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth intensive operations. Such allocation of functions is exemplary only. In one implementation, the high-speed controller 508 is coupled to memory 504, display 516, e.g., through a graphics processor or accelerator, and to high-speed expansion ports 510, which can accept various expansion cards (not shown). In the implementation, low-speed controller 512 is coupled to storage device 506 and low-speed expansion port 514. The low-speed expansion port, which can include various communication ports, e.g., USB, Bluetooth, Ethernet, wireless Ethernet can be coupled to one or more input/output devices, such as a keyboard, a pointing device, microphone/speaker pair, a scanner, or a networking device such as a switch or router, e.g., through a network adapter. The computing device 500 can be implemented in a number of different forms, as shown in the figure. For example, it can be implemented as a standard server 520, or multiple times in a group of such servers. It can also be implemented as part of a rack server system 524. In addition, it can be implemented in a personal computer such as a laptop computer 522. Alternatively, components from computing device 500 can be combined with other components in a mobile device (not shown), such as device 550. Each of such devices can contain one or more of computing device 500, 550, and an entire system can be made up of multiple computing devices 500, 550 communicating with each other.

The computing device 500 can be implemented in a number of different forms, as shown in the figure. For example, it can be implemented as a standard server 520, or multiple times in a group of such servers. It can also be implemented as part of a rack server system 524. In addition, it can be implemented in a personal computer such as a laptop computer 522. Alternatively, components from computing device 500 can be combined with other components in a mobile device (not shown), such as device 550. Each of such devices can contain one or more of computing device 500, 550, and an entire system can be made up of multiple computing devices 500, 550 communicating with each other

Computing device 550 includes a processor 552, memory 564, and an input/output device such as a display 554, a communication interface 566, and a transceiver 568, among other components. The device 550 can also be provided with a storage device, such as a micro-drive or other device, to provide additional storage. Each of the components 550, 552, 564, 554, 566, and 568, are interconnected using various buses, and several of the components can be mounted on a common motherboard or in other manners as appropriate.

The processor 552 can execute instructions within the computing device 550, including instructions stored in the memory 564. The processor can be implemented as a chipset of chips that include separate and multiple analog and digital processors. Additionally, the processor can be implemented using any of a number of architectures. For example, the processor 510 can be a CISC (Complex Instruction Set Computers) processor, a RISC (Reduced Instruction Set Computer) processor, or a MISC (Minimal Instruction Set Computer) processor. The processor can provide, for example, for coordination of the other components of the device 550, such as control of user interfaces, applications run by device 550, and wireless communication by device 550.

Processor 552 can communicate with a user through control interface 558 and display interface 556 coupled to a display 554. The display 554 can be, for example, a TFT (Thin-Film-Transistor Liquid Crystal Display) display or an OLED (Organic Light Emitting Diode) display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can be provide in communication with processor 552, so as to enable near area communication of device 550 with other devices. External interface 562 can provide, for example, for wired communication in some implementations, or for wireless communication in other implementations, and multiple interfaces can also be used.

The memory 564 stores information within the computing device 550. The memory 564 can be implemented as one or more of a computer-readable medium or media, a volatile memory unit or units, or a non-volatile memory unit or units. Expansion memory 574 can also be provided and connected to device 550 through expansion interface 572, which can include, for example, a SIMM (Single In Line Memory Module) card interface. Such expansion memory 574 can provide extra storage space for device 550, or can also store applications or other information for device 550. Specifically, expansion memory 574 can include instructions to carry out or supplement the processes described above, and can include secure information also. Thus, for example, expansion memory 574 can be provide as a security module for device 550, and can be programmed with instructions that permit secure use of device 550. In addition, secure applications can be provided via the SIMM cards, along with additional information, such as placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that can be received, for example, over transceiver 568 or external interface 562.

Device 550 can communicate wirelessly through communication interface 566, which can include digital signal processing circuitry where necessary. Communication interface 566 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 568. In addition, short-range communication can occur, such as using a Bluetooth, Wi-Fi, or other such transceiver (not shown). In addition, GPS (Global Positioning System) receiver module 570 can provide additional navigation- and location-related wireless data to device 550, which can be used as appropriate by applications running on device 550.

Device 550 can also communicate audibly using audio codec 560, which can receive spoken information from a user and convert it to usable digital information. Audio codec 560 can likewise generate audible sound for a user, such as through a speaker, e.g., in a handset of device 550. Such sound can include sound from voice telephone calls, can include recorded sound, e.g., voice messages, music files, etc. and can also include sound generated by applications operating on device 550.

The computing device 550 can be implemented in a number of different forms, as shown in the figure. For example, it can be implemented as a cellular telephone 580. It can also be implemented as part of a smartphone 582, personal digital assistant, or other similar mobile device.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A system for transaction verification, comprising:
one or more processors; and
one or more storage devices, wherein the one or more storage devices includes instructions that, when executed by the one or more processors, cause the one or more processors to perform operations, the operations comprising:
receiving, by a first enterprise transaction verification system, first data that represents at least a portion of a physical document identifying a party of a transaction;
generating second data that represents an obfuscation of the first data, wherein generating the second data comprises:
providing the first data as an input to a machine learning model that has been trained to include a security feature discriminator layer;
obtaining a set of activations output by a security feature discriminator layer of the machine learning model, wherein the second data comprises the set of activations;
determining, by the first enterprise transaction verification system and based on the second data, whether the transaction is a transaction that is to be denied;
based on determining that the transaction is to be denied, updating a database of a collaborative verification system to include one or more data records that comprise the second data for a predetermined amount of time, the collaborative verification system enabling preemptive denial of one or more other transactions by the party at other enterprises that are members of the collaborative verification system.

2. The system of claim 1, the operations further comprising:
providing data stored by the collaborative verification system to one or more other enterprise transaction verification systems.

3. The system of claim 1, wherein the one or more data records are accessible by one or more other enterprise verification systems of the other enterprises that are members of the collaborative verification system.

4. The system of claim 1, wherein updating the database of the collaborative verification system to include one or more data records that comprise the second data for a predetermined amount of time comprises:
storing, by the collaborative verification system, the second data in an entity record in a bad-actor list, wherein each entity record of the bad-actor list corresponds to an entity whose transactions are to be denied for at least a predetermined amount of time.

5. The system of claim 1, wherein the operations further comprise:
subsequent to updating the database of the collaborative verification system:
receiving, by a second enterprise transaction verification system, different data that represents at least a portion of the physical document identifying a party to a different transaction;
generating third data that represents an obfuscation of the different data, wherein generating the third data comprises:
providing the different data as an input to a second machine learning model that has been trained to include a security feature discriminator layer;
obtaining a different set of activations output by a security feature discriminator layer of the second machine learning model, wherein the third data comprises the different set of activations;
determining, by the second enterprise transaction verification system, that the third data is within a predetermined level of similarity to the second data stored in the database of the collaborative verification system; and
based on determining that the third data is within a predetermined level of similarity to the second data, determining that the different transaction is to be denied.

6. The system of claim 1, wherein the machine learning model has been trained to determine a likelihood that data representing an input image depicts at least a portion of a legitimate physical document.

7. The system of claim 1, wherein the security feature discriminator layer is trained to detect the presence of a document security feature in an image of the physical document or the absence of a document security feature in an image of the physical document.

8. A method for transaction verification, comprising:
receiving, by a first enterprise transaction verification system, first data that represents at least a portion of a physical document identifying a party of a transaction;
generating second data that represents an obfuscation of the first data, wherein generating the second data comprises:
providing the first data as an input to a machine learning model that has been trained to include a security feature discriminator layer;
obtaining a set of activations output by a security feature discriminator layer of the machine learning model, wherein the second data comprises the set of activations;
determining, by the first enterprise transaction verification system and based on the second data, whether the transaction is a transaction that is to be denied;
based on determining that the transaction is to be denied, updating a database of a collaborative verification system to include one or more data records that comprise the second data for a predetermined amount of time, the collaborative verification system enabling preemptive denial of one or more other transactions by the party at other enterprises that are members of the collaborative verification system.

9. The method of claim 8, the method further comprises:
providing data stored by the collaborative verification system to one or more other enterprise transaction verification systems.

10. The method of claim 8, wherein the one or more data records are accessible by one or more other enterprise verification systems of the other enterprises that are members of the collaborative verification system.

11. The method of claim 8, wherein updating the database of the collaborative verification system to include one or more data records that comprise the second data for a predetermined amount of time comprises:
storing, by the collaborative verification system, the second data in an entity record in a bad-actor list, wherein each entity record of the bad-actor list corresponds to an entity whose transactions are to be denied for at least a predetermined amount of time.

12. The method of claim 8, wherein the method further comprises:
subsequent to updating the database of the collaborative verification system:
receiving, by a second enterprise transaction verification system, different data that represents at least a portion of the physical document identifying a party to a different transaction;
generating third data that represents an obfuscation of the different data, wherein generating the third data comprises:
providing the different data as an input to a second machine learning model that has been trained to include a security feature discriminator layer;
obtaining a different set of activations output by a security feature discriminator layer of the second machine learning model, wherein the third data comprises the different set of activations;
determining, by the second enterprise transaction verification system, that the third data is within a predetermined level of similarity to the second data stored in the database of the collaborative verification system; and
based on determining that the third data is within a predetermined level of similarity to the second data, determining that the different transaction is to be denied.

13. The method of claim 8, wherein the machine learning model has been trained to determine a likelihood that data representing an input image depicts at least a portion of a legitimate physical document.

14. The method of claim 8, wherein the security feature discriminator layer is trained to detect the presence of a document security feature in an image of the physical document or the absence of a document security feature in an image of the physical document.

15. A non-transitory computer-readable medium storing software comprising instructions executable by one or more computers which, upon such execution, cause the one or more computers to perform operations comprising:
receiving, by a first enterprise transaction verification system, first data that represents at least a portion of a physical document identifying a party of a transaction;
generating second data that represents an obfuscation of the first data, wherein generating the second data comprises:
providing the first data as an input to a machine learning model that has been trained to include a security feature discriminator layer;
obtaining a set of activations output by a security feature discriminator layer of the machine learning model, wherein the second data comprises the set of activations;
determining, by the first enterprise transaction verification system and based on the second data, whether the transaction is a transaction that is to be denied;
based on determining that the transaction is to be denied, updating a database of a collaborative verification system to include one or more data records that comprise the second data for a predetermined amount of time, the collaborative verification system enabling preemptive denial of one or more other transactions by the party at other enterprises that are members of the collaborative verification system.

16. The computer-readable medium of claim 15, the operations further comprising:
providing data stored by the collaborative verification system to one or more other enterprise transaction verification systems.

17. The computer-readable medium of claim 15, wherein the one or more data records are accessible by one or more other enterprise verification systems of the other enterprises that are members of the collaborative verification system.

18. The computer-readable medium of claim 15, wherein updating the database of the collaborative verification system to include one or more data records that comprise the second data for a predetermined amount of time comprises:
storing, by the collaborative verification system, the second data in an entity record in a bad-actor list, wherein each entity record of the bad-actor list corresponds to an entity whose transactions are to be denied for at least a predetermined amount of time.

19. The computer-readable medium of claim 15, the operations further comprising:
subsequent to updating the database of the collaborative verification system:
receiving, by a second enterprise transaction verification system, different data that represents at least a portion of the physical document identifying a party to a different transaction;
generating third data that represents an obfuscation of the different data, wherein generating the third data comprises:
providing the different data as an input to a second machine learning model that has been trained to include a security feature discriminator layer;
obtaining a different set of activations output by a security feature discriminator layer of the second machine learning model, wherein the third data comprises the different set of activations;
determining, by the second enterprise transaction verification system, that the third data is within a predetermined level of similarity to the second data stored in the database of the collaborative verification system; and
based on determining that the third data is within a predetermined level of similarity to the second data, determining that the different transaction is to be denied.

20. The computer-readable medium of claim 15, wherein the security feature discriminator layer is trained to detect the presence of a document security feature in an image of the physical document or the absence of a document security feature in an image of the physical document.
